(19) United States
(12) Patent Application Publication
(10) Pub. No.: US 2009/0267907 A1
(43) Pub. Date: Oct. 29, 2009

(54) Information Processing Apparatus, Display Controlling Method and Program Thereof

(75) Inventor: Tatsuyoshi Noma, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/270,651

(22) Filed: Nov. 13, 2008

(30) Foreign Application Priority Data
Apr. 28, 2008 (JP) 2008-117782

(51) Int. Cl. G06F 3/041

(52) U.S. Cl. 345/173

(57) ABSTRACT

According to one embodiment, an information processing apparatus, includes a display module which comprises a touch sensor on a display surface, a detecting module which detects a range surrounded by a position where a user's finger touches the display surface of the display module, and a position where the user's finger takes off from the display surface after moving on the display surface while touching, and an enlargement display module which enlarges an object in the range on the display module while keeping the object in an operable status if the range is detected by the detecting module.

### CROSS-REFERENCE TO RELATED APPLICATIONS

This application is based upon and claims the benefit of priority from Japanese Patent Application No. 2008-117782, filed Apr. 28, 2008, the entire contents of which are incorporated herein by reference.

### BACKGROUND

1. Field

One embodiment of the present invention relates to a control technique of an information processing apparatus comprising a touch sensor and, more particularly, to an information processing apparatus, display controlling method and program capable of allowing displayed object data to be viewed and used easily.

2. Description of the Related Art

In general, in PDA having a touch sensor built in a display, a display area of the display small. Such a device has a problem with improvement of visibility when a great amount of information is displayed on the display. For example, JP-A Publication No. 2004-152217 discloses a technique of allowing a touch operation on the display, expanding an area around a touched area in another window, and thereby improving the visibility and facilitating the touch operation using a finger.

According to the technique disclosed in JP-A Publication No. 2004-152217, however, an unenlarged general screen needs to be operated to operate the enlarged object. In addition, an enlarged range cannot be designated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary illustration showing an outer appearance of an information processing apparatus according to an embodiment of the present invention;

FIG. 2 is an exemplary block diagram showing main components of the information processing apparatus according to the embodiment;

FIG. 3 is an exemplary block diagram showing a functional configuration of a display control application in the information processing apparatus according to the embodiment;

FIG. 4 is an exemplary flowchart showing a display controlling method to which the information processing apparatus according to the embodiment is applied;

FIG. 5 is an exemplary illustration showing a predetermined screen displayed on a display of the information processing apparatus according to the embodiment;

FIG. 6 is an exemplary illustration showing a state in which a range surrounded on the display of the information processing apparatus according to the embodiment is recognized;

FIG. 7 is an exemplary illustration showing an extension displayed on the display of the information processing apparatus according to the embodiment;

FIG. 8 is an exemplary illustration showing a state in which a range surrounded on the display of the information processing apparatus according to the embodiment is recognized;

FIG. 9 is an exemplary illustration showing an extension displayed on the display of the information processing apparatus according to the embodiment;

FIG. 10 is an exemplary illustration showing a method of extracting an enlarged range from a recognized range by the information processing apparatus according to the embodiment;

FIG. 11 is an exemplary illustration showing a scroll display on the display of the information processing apparatus according to the embodiment;

FIG. 12 is an exemplary illustration showing enlarged ranges superposed on the display of the information processing apparatus according to the embodiment;

FIG. 13 is an exemplary illustration showing enlarged ranges moved on the display of the information processing apparatus according to the embodiment; and

FIG. 14 is an exemplary flowchart showing a method of designating an enlarged range on a display of an information processing apparatus according to a second embodiment.

### DETAILED DESCRIPTION

Various embodiments according to the invention will be described hereinafter with reference to the accompanying drawings. In general, according to one embodiment of the invention, an information processing apparatus, includes: a display unit which comprises a touch sensor on a display surface; a detecting unit (module) which detects a range surrounded by a position where a user's finger touches the display surface of the display unit, and a position where the user's finger takes off from the display surface after moving on the display surface while touching; and an enlargement display unit which enlarges an object in the range on the display unit while keeping the object in an operable status if the range is detected by the detecting unit.

Embodiments of the present invention are described with reference to accompanying drawings.

### First Embodiment

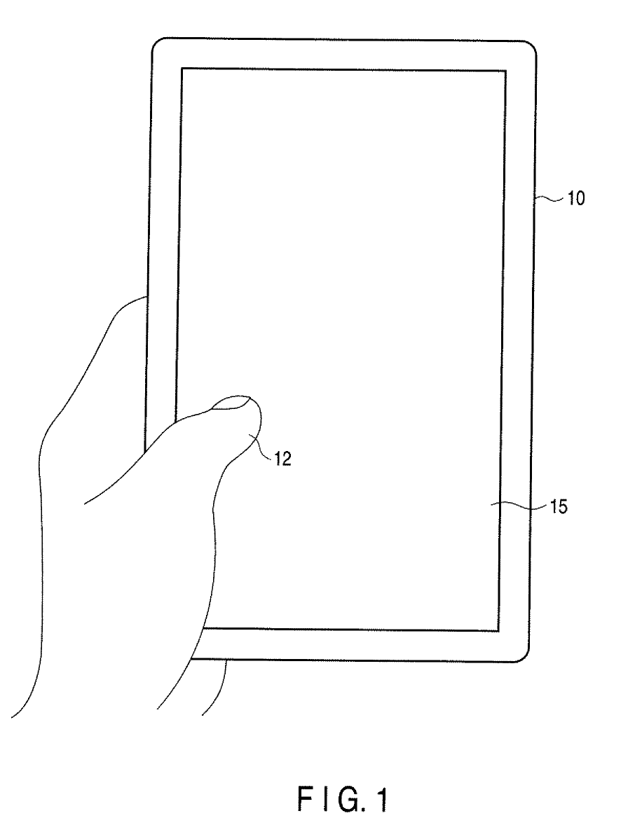

First, a configuration of an information processing apparatus according to the first embodiment of the present invention is described with reference to FIG. 1.

FIG. 1 is an illustration showing an outer appearance of the information processing apparatus to which a control method of the present invention is applied. In the present embodiment, the information processing apparatus is implemented as PDA (Personal Digital Assistants) provided with a display (touch display) in which a touch sensor is built.

As shown in FIG. 1, PDA 10 comprises a display (display unit) 15 in which a touch sensor is built. By touching a surface of the display 15 by a finger 12 or a touch pen, contents displayed on the screen can be selected or their ranges can be designated. The display 15 is applicable to multi-touch. Multi-touch is an action of simultaneously touching two fingers when the display 15 is pushed down with the finger 12.

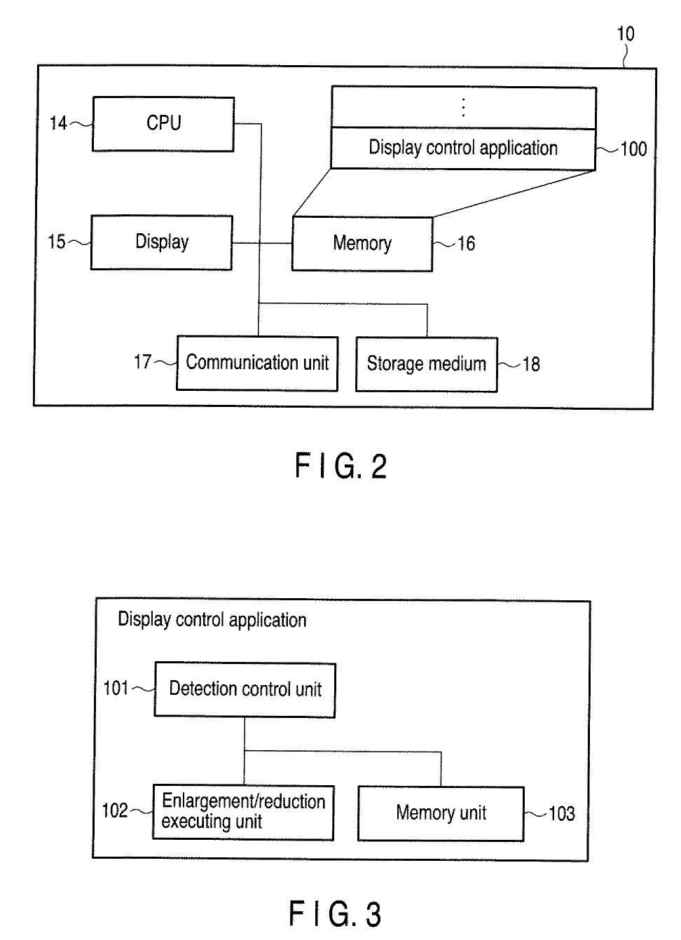

FIG. 2 is a block diagram showing a main configuration of the PDA serving as the information processing apparatus according to the present embodiment.

As shown in FIG. 2, the PDA 10 comprises a CPU (detecting unit, extension display unit) 14, the display 15, a memory 16, a communication unit (module) 17 and the like.

The CPU 14 is a control unit (module) which totally controls various devices of the PDA 10. The CPU 14 loads the OS (operating system), and various applications such as display control application 100 stored in a storage medium 18 on the memory 16. The memory 16 is a storage medium such a flash memory which temporarily stores the data. The display 15 is a display unit in which a touch sensor is built. The display 15 allows a process such as selecting a predetermined area on the display in response to pushing using a user's finger or touch pen. The storage medium 18 stores the OS, various applications and the like, with a greater capacity than the HDD, the memory 16 such as a flash memory and the like. The communication unit 17 is a connection interface which makes a connection with Internet, or a 3G module for wireless LAN functions, cellular telephones and the like.

Next, a functional configuration of a display control application 100 is described with reference to a block diagram of FIG. 3.

The display control application 100 comprises a detection control unit (module) 101, a scaling execution unit (module) 102, and a memory unit (module) 103. The detection control unit 101 detects pushing of a user's finger 12, a touch pen or the like. In other words, the detection control unit 101 detects an operation of forming a predetermined range such that it is surrounded by a push starting point (starting point) where pushing is executed by the touch input and a pushing release point (end point) where pushing is taken off from the display 15 (i.e., a range surrounded by a position where the finger touches on the display surface of the display 15 and a position where the finger releases after moving on the display surface while touching). The scaling execution unit 102 executes a process of enlarging an object (image data or the like) in the surrounded range. The enlarged object can execute an operation provided originally with the object. For example, if the enlarged object is an icon, an application associated with the icon can be executed by clicking. The memory unit 104 stores detection information of detecting pushing of a user's finger 12, a touch pen or the like. The detection information is a definition file which indicates definition of the operation of surrounding the range by the touch input on the display 15.

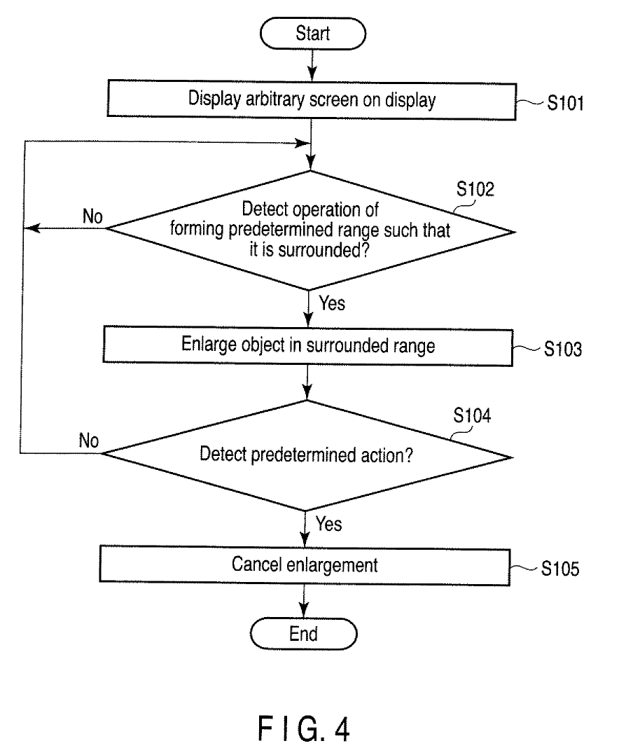

Next, a display control method to which the information processing apparatus of the present embodiment is applied is described with reference to a flowchart of FIG. 4.

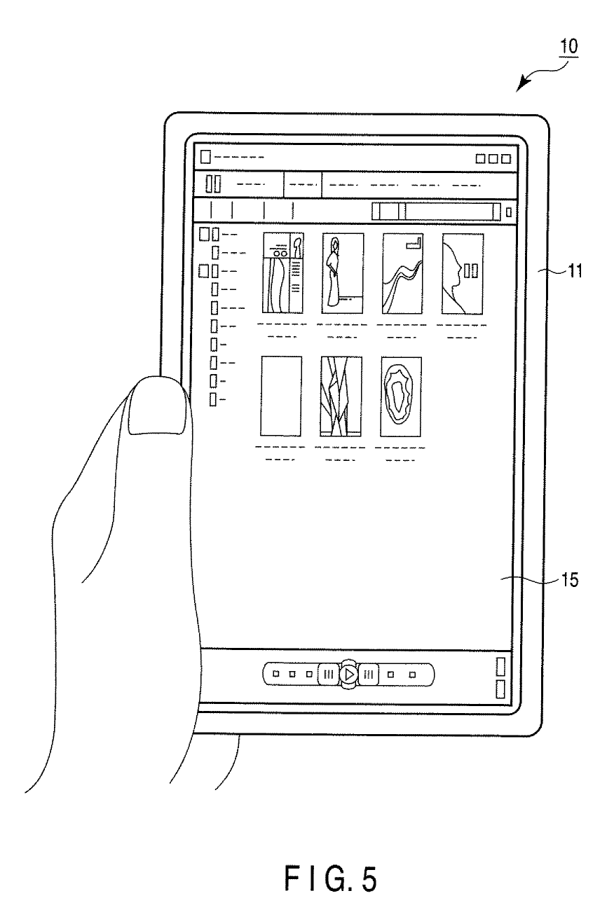

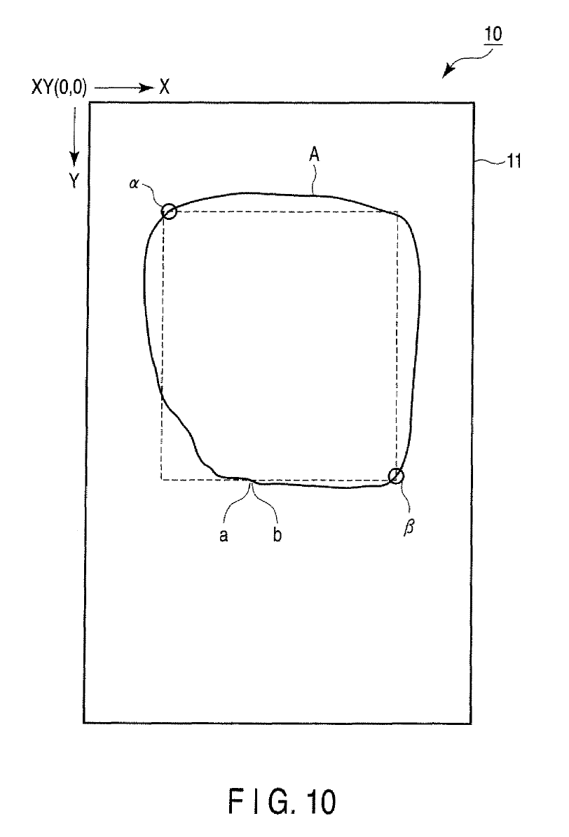

First, the display control application 100 is read from the storage medium IS by the CPU 14 of the PDA 10 and then activated. The display control application 100 displays an arbitrary screen on the display 15 (block S101: FIG. 5). After activated, the display control application 100 is resident in the operating system of the PDA 10. The display control application 100 monitors the operation of forming the predetermined range such that it is surrounded, by pushing on the display 15 by the user (touch operation) (block S102). The operation of forming the predetermined range such that it is surrounded is, for example, to recognize that it is surrounded if a distance between the push start point (point where pushing is started, starting point: “a” in FIG. 10) and the push release point (point where the pushing is taken off from the display 15, end point: “b” in FIG. 10) shown in FIG. 10 is shorter than a constant distance, for example, 10 dots. Designation of a range using multi-touch can be executed.

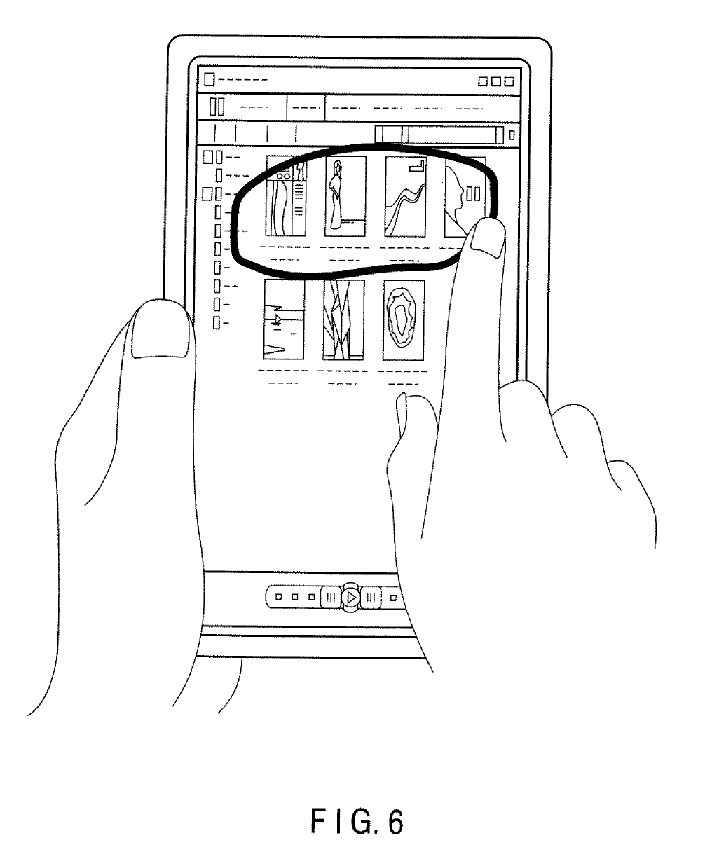

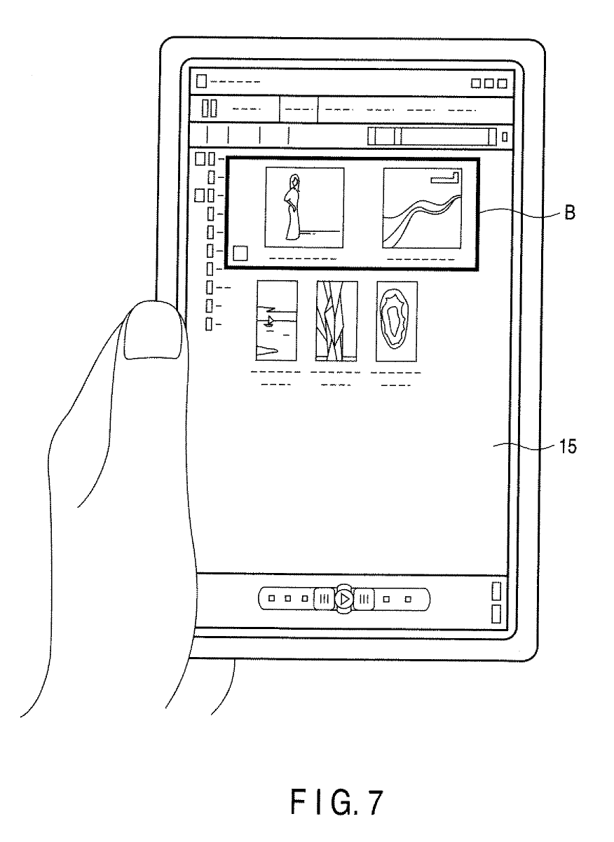

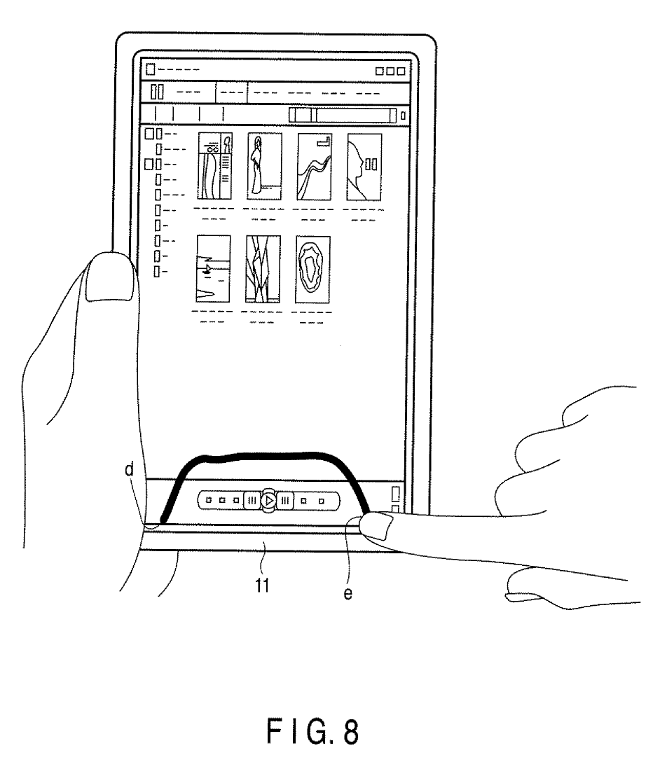

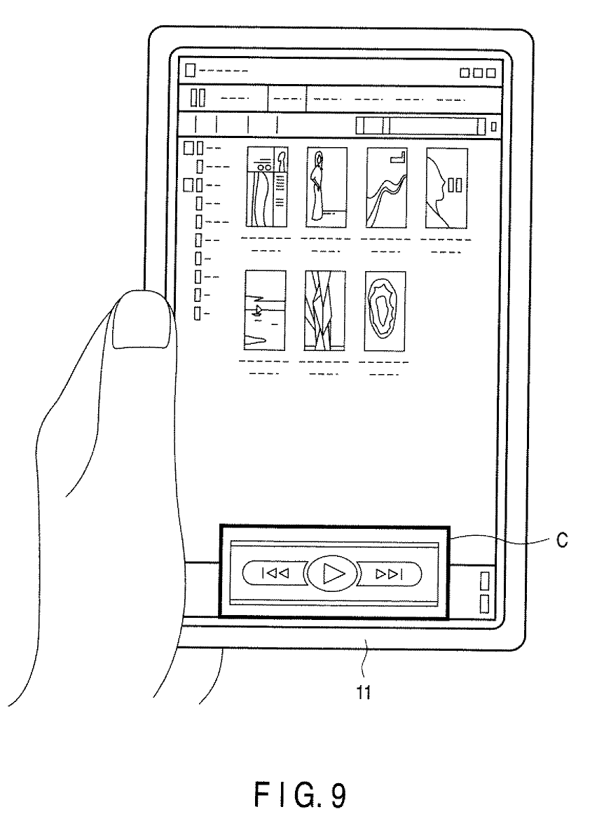

Next, if the operation of forming the predetermined range such that it is surrounded is detected by the display control application 100 (YES in block S102: FIG. 6), an object of the surrounded range is enlarged (block S103). When the object of the surrounded range is enlarged, for example, the enlarged range is determined in the following manner. If the surrounded range is a range as shown in, for example, FIG. 10, a minimum value α and a maximum value β of each of X and Y are obtained where coordinates are determined with a lateral axis X and a longitudinal axis Y based on an upper left corner of the display 15. Then, a rectangular area A having a rectangular line passing at α and β is extracted. The rectangular area A is regarded as the enlarged area. For example, if an area is surrounded as shown in FIG. 6, the enlarged area is an area B shown in FIG. 7. Similarly, if an area is surrounded as shown in FIG. 8, the enlarged area is an area C shown in FIG. 9. If the area is surrounded as shown in FIG. 8, it is recognized as a surrounded area including a starting point “d”, an end point “e”, and an outer frame 11 of the display 15 (if a part of the outer frame 11 overlaps the surrounded area, the area including the outer frame 11 is detected). In this case, too, the minimum value α and the maximum value β of each of X and Y are obtained. Then, the rectangular area C having a rectangular line passing at α and β is extracted. The rectangular area C is regarded as the enlarged area (FIG. 9). When the range includes the outer frame 11, the minimum value α and the maximum value β of each of X and Y must be in a predetermined distance from the outer frame 11 (for example, a quarter of a length of the outer frame 11). If they are so remote from the outer frame 11, an expected operation is included in the surrounding operation.

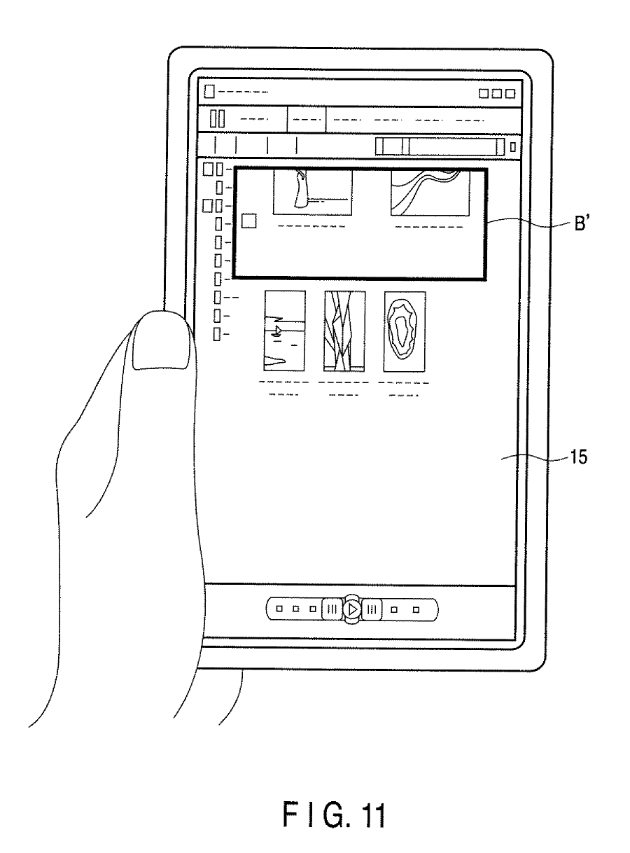

In the enlarged state, the object in the range enlarged by the display control application 100 can execute an operation provided originally with the object. For example, a displayed operation panel can be pushed down as shown in FIG. 9. In addition, if an icon is displayed in the enlarged range, the operation can be executed by clicking the icon. Furthermore, by scrolling and moving the display in the enlarged range B by the touch operation as shown in FIG. 7, an area B′ can be displayed (FIG. 11).

If a predetermined action is detected by the display control application 100 (YES in block S104), the enlargement display is canceled (reduction display: reducing in a pre-enlarged size and displaying again) (block S105). The predetermined action is, for example, to execute an operation different from the operation in the range enlarged by the user, i.e., an operation in an unenlarged range, or to execute an operation opposite to the operation at the enlargement, i.e., an operation of surrounding a range having the end point “b” as the starting point and the starting point “a” as the end point as shown in FIG. 10, or to execute an operation of surrounding a range having the end point “e” as the starting point and the starting point “d” as the end point as shown in FIG. 8. At the multi-touch operation, too, the enlargement display is canceled by executing the opposite operation (reduction display).

On the other hand, if the predetermined action is not detected by the display control application 100 in block S104 (NO in block S104), the process proceeds to block S102. If the operation of forming the predetermined range such that it is surrounded is detected by the display control application 100 in block S102 (YES in block S102), the object in the surrounded range is enlarged again. For the object in the range which is enlarged again, too, the above-described object operation or scrolling in the range which is enlarged again can be executed. In this status, if the predetermined action is detected by the display control application 100 in block S104 (YES in block S104), the enlargement display returns to the status of the previous enlargement display by one step. The enlargement display may be set at up to two times. Furthermore, if the predetermined action is detected by the display control application 100 in block S104, the enlargement display may return to the standard display at one time.

Moreover, if the range of moving images is enlarged, a plurality of screen shots in the moving images may be obtained, and the obtained screen shots may be changed and displayed similarly to a frame-dropped movie.

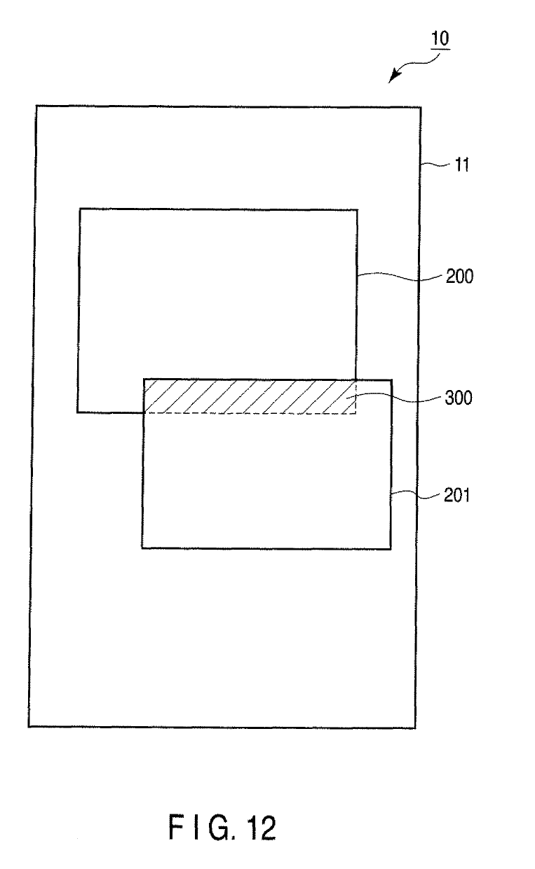

In addition, two or more enlarged ranges may be set. In this case, if the enlarged ranges overlap, for example, if an enlarged range 200 (enlargement ratio at 2 times) and an enlarged range 201 (enlargement ratio at 2 times) overlap as shown in FIG. 12, the enlargement ratio in an overlapped range 300 is, for example, a product of both the enlargement ratios, 2*2=4 times. The enlargement ratio in the overlapped range 300 is not limited to this, but may be a sum of both the enlargement ratios.

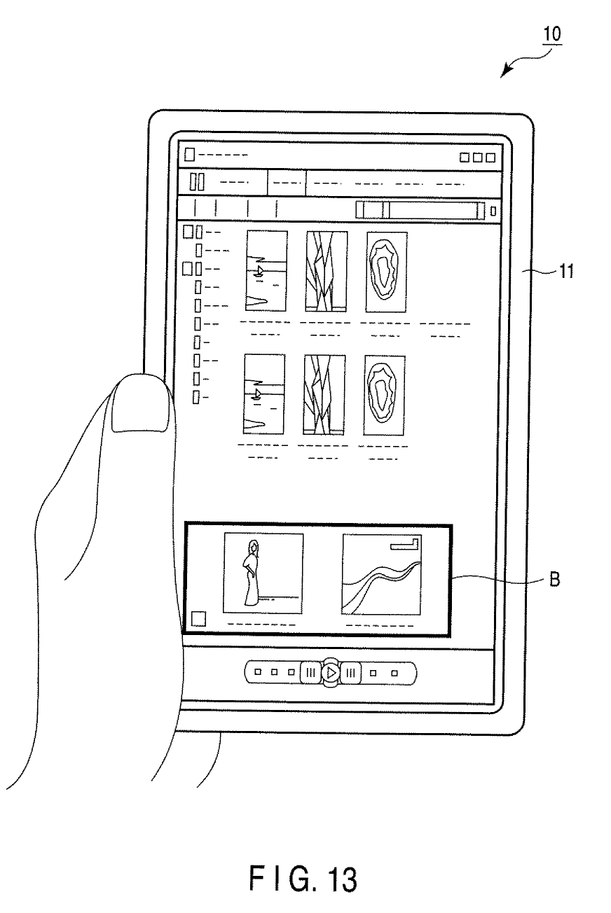

Furthermore, the enlarged range can be moved. For example, an enlarged range B can be moved to an edge of the display 15 so as not to disturb viewing as shown in FIG. 13. In addition, the enlarged range can be fixed so as to prevent the enlargement from being canceled automatically by an operation outside the enlarged range.

According to the above-described first embodiment, the desired range can be enlarged and the enlarged object can be operated. In addition, another application for music, etc. can be operated while enlarging the moving images.

### Second Embodiment

Besides the above-described embodiment, for example, the range can be designated in the following manner.

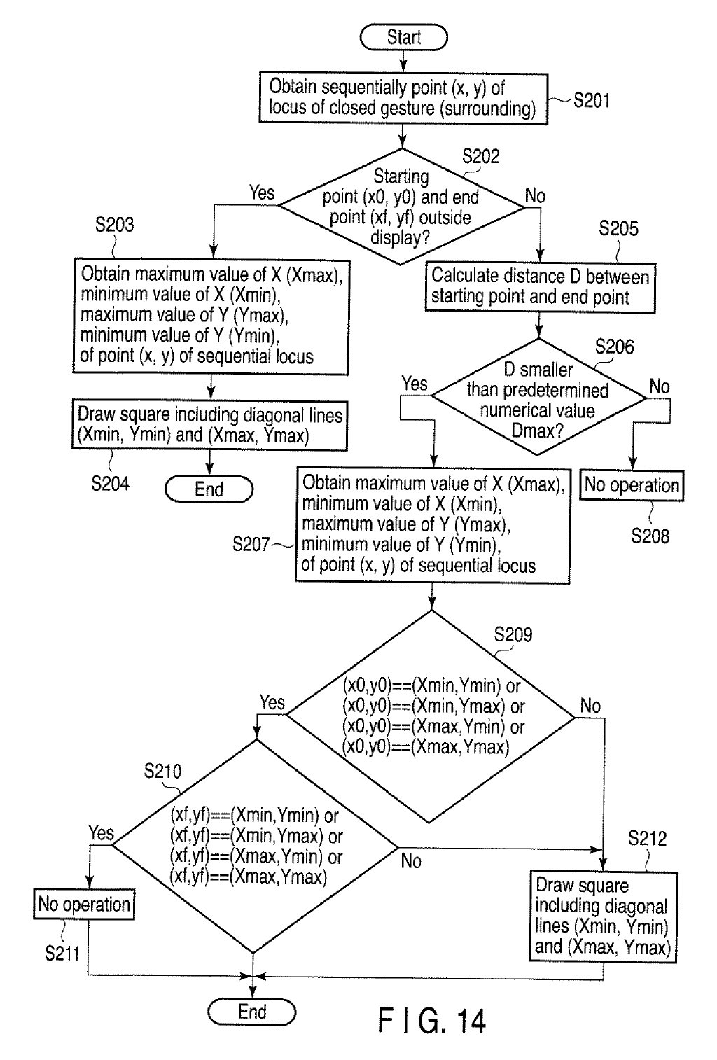

FIG. 14 is a flowchart showing a display controlling method according to another embodiment. If the CPU 14 detects a surrounding operation of the user's finger 12 (closed gesture) (if the CPU 14 detects an operation of surrounding a range between a position where the finger touches on the display surface of the display 15 and a position where the finger takes off from the display surface after moving on the display surface while touching), the CPU 14 (block S201). If it is discriminated in block S202 by the CPU 14 that the starting point (x0, y0) and the end point (xf, yf) are outside the display 15 (YES in block S202), the CPU 14 obtains the maximum value of X (Xmax), the minimum value of X (Xmin), the maximum value of Y (Ymax) and the minimum value of Y (Ymin), of the points (x, y) of the sequential locus (block S203). On the basis of the obtained (Xmin, Ymin) and (Xmax, Ymax), the CPU 14 draws a square (enlarged range) including a diagonal line of (Xmin, Ymin) and (Xmax, Ymax) (block S204). On the other hand, if it is discriminated in block S202 by the CPU 14 that the starting point (x0, y0) and the end point (xf, yf) are not outside the display 15 (NO in block S202), the CPU 14 calculates a distance D between the starting point and the end point (block S205). In block S206, the CPU 14 discriminates whether or not the distance D between the starting point and the end point is smaller than a determined numerical value Dmax (block S206). If it is discriminated in block S206 by the CPU 14 that the distance D between the starting point and the end point is greater than the determined numerical value Dmax (NO in block S206), the CPU 14 ends the operation without executing any process (block S208). On the other hand, if it is discriminated in block S206 by the CPU 14 that the distance D between the starting point and the end point is smaller than the determined numerical value Dmax (YES in block 5206), the CPU 14 obtains the maximum value of X (Xmax), the minimum value of X (Xmin), the maximum value of Y (Ymax) and the minimum value of Y (Ymin), of the points (x, y) of the sequential locus (block S207). Next, the CPU 14 discriminates whether or not the following condition is met, on the basis of the obtained maximum value of X (Xmax), the minimum value of X (Xmin), the maximum value of Y (Ymax) and the minimum value of Y (Ymin) (block S209)

(x0,y0)==(Xmin,Ymin) or

(x0,y0)==(Xmin,Ymax) or

(x0,y0)==(Xmax,Ymin) or

(x0,y0)==(Xmax,Ymax) (Condition 1)

In other words, the CPU 14 discriminates at least one of four conditions, “x0 matches Xmin, and y0 matches Ymin”, “x0 matches Xmin, and y0 matches Ymax”, “x0 matches Xmax, and y0 matches Ymin” and “x0 matches Xmax, and y0 matches Ymax”, is met.

If the CPU 14 discriminates in block S209 that the (Condition 1) is not met (NO in block S209), the CPU 14 draws a square (enlarged range) including a diagonal line of (Xmin, Ymin) and (Xmax, Ymax) (block S212). On the other hand, if the CPU 14 discriminates in block S209 that the (Condition 1) is met (YES in block S209), the CPU 14 discriminates whether or not the following condition is met, on the basis of the obtained maximum value of X (Xmax), the minimum value of X (Xmin), the maximum value of Y (Ymax) and the minimum value of Y (Ymin) (block S210).

(xf,yf)==(Xmin,Ymin) or

(xf,yf)==(Xmin,Ymax) or

(xf,yf)==(Xmax,Ymin) or

(xf,yf)==(Xmax,Ymax) (Condition 2)

In other words, the CPU 14 discriminates at least one of four conditions, “xf matches Xmin, and yf matches Ymin”, “xf matches Xmin, and yf matches Ymax”, “xf matches Xmax, and yf matches Ymin” and “xf matches Xmax, and yf matches Ymax”, is met.

If the CPU 14 discriminates in block S210 that the (Condition 2) is not met (NO in block S210), the CPU 14 draws a square (enlarged range) including a diagonal line of (Xmin, Ymin) and (Xmax, Ymax) (block S212). If the CPU 14 discriminates in block S210 that the (Condition 2) is met (YES in block S210), the CPU 14 ends the operation without executing any process (block S211).

The object of the present invention is to provide an information processing apparatus, display controlling method, and program capable of allowing a desired range to be enlarged and operating an enlarged object.

In the above-described second embodiment, too, the same advantage as that of the first embodiment can be obtained. The present invention can be applied not only to the above-described embodiments, but also to a method of designating a range with a touch panel, similarly to the above-described embodiments.

The present invention is not limited to the embodiments described above but the constituent elements of the invention can be modified in various manners without departing from the spirit and scope of the invention.

Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a display module which comprises a touch sensor on a display surface;
a detecting module which detects a range surrounded by a position where a user's finger touches the display surface of the display module, and a position where the user's finger takes off from the display surface after moving on the display surface while touching; and
an enlargement display module which enlarges an object in the range on the display module while keeping the object in an operable status if the range is detected by the detecting module.

2. The apparatus of claim 1, wherein the display module displays an outer frame on a displayed image and, if a part of the outer frame overlaps the surrounded range, the detecting module detects the range including the outer frame.

3. The apparatus of claim 1, wherein the display enlarged by the enlargement display module is capable of being further enlarged.

4. The apparatus of claim 3, wherein the object displayed in the range is enlarged in a status which enables an operation provided with the object to be executed.

5. The apparatus of claim 1, wherein the display enlarged by the enlargement display module is reduced in size to the pre-enlarged display and then displayed again.

6. A display controlling method employed in an information processing apparatus comprising a display module which has a touch sensor on a display surface, comprising:
detecting a range surrounded by a position where a user's finger touches the display surface of the display module, and a position where the user's finger takes off from the display surface after moving on the display surface while touching; and
enlarging an object in the range on the display module while keeping the object in an operable status if the range is detected.

7. The method of claim 6, wherein the display module comprises a determined outer frame, and the range is formed such that the determined range is surrounded together with the outer frame.

8. The method of claim 6, wherein the display enlarged by the enlargement display module is capable of being further enlarged.

9. The method of claim 8, wherein the object displayed in the range is enlarged in a status which enables an operation provided with the object to be executed.

10. The method of claim 6, wherein the display enlarged by the enlargement display module is reduced in size to the pre-enlarged display and then displayed again.

11. A digital information recording medium storing a program employed in an information processing apparatus which comprises a display module which has a touch sensor on a display surface,
the program urging a computer to execute:
detecting a range surrounded by a position where a user's finger touches the display surface of the display module, and a position where the user's finger takes off from the display surface after moving on the display surface while touching; and
enlarging an object in the range on the display module while keeping the object in an operable status if the range is detected by the detection.
